(19) United States
(12) Patent Application Publication
(10) Pub. No.: US 2009/0065023 A1
(43) Pub. Date: Mar. 12, 2009

(54) Microwave assisted post-FPI cleaning method

(75) Inventors: Garimella Balaji Rao, Singapore (SG); Kok Hai Luah, Singapore (SG); Wee Kwong Na, Singapore (SG)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Turbine Overhaul Services Pte Ltd, Jurong Town (SG)

(21) Appl. No.: 12/005,976

(22) Filed: Dec. 28, 2007

(30) Foreign Application Priority Data
Sep. 10, 2007 (SG) 200706581-6

(51) Int. Cl. B08B 3/10

(52) U.S. Cl. 134/1; 134/58 R

(57) ABSTRACT

A method for cleaning a gas turbine engine component following a fluorescent penetrant inspection process comprises immersing the component in a cleaning solution and heating the component in a microwave oven while immersed in the cleaning solution for a period of time.

### BACKGROUND

The present invention relates to a method for cleaning gas turbine engine components. More specifically, the present invention relates to a microwave assisted cleaning method for gas turbine engine components following fluorescent penetration inspection.

Gas turbine engines operate under extremely high heat and pressure. These rigorous operating conditions place a great amount of stress on certain engine components, particularly turbine blades and vanes downstream of the compressor. While gas turbine blades and vanes are generally designed to withstand high levels of mechanical and thermal stress, under certain circumstances cracks may still develop in these components.

A number of non-destructive techniques are employed for the detection of cracks or imperfections. Fluorescent penetration inspection (FPI) is the most widely used non-destructive method for inspecting gas turbine engine components, such as blades and vanes. The FPI process involves immersing the component in a penetrant for some period of time. The component is then cleaned to remove all penetrant except that contained in defects, and developer is added to widen the penetrant indication. The component is inspected under ultraviolet light.

Upon completion of the inspection process, the component must be cleaned to remove residual penetrant on the part's surface. Currently, post-FPI cleaning processes include ultrasonic cleaning, alkaline cleaning, use of a hot water wash, and combinations thereof. However, these methods require a prolonged processing time and do not thoroughly clean the component. In addition, a heating process is sometimes used in which the component is heated to a high temperature (i.e. about 425 to about 600 degrees Celsius) in order to burn away the remaining penetrant. This method is more effective in removing the penetrant, but requires a large amount of energy and results in discoloration of the part, which is unsightly.

Thus, there is a need in the art for a post-FPI cleaning method for gas engine components that quickly and effectively removes residual penetrant while maintaining the pre-FPI appearance of the component.

### SUMMARY

The present invention is a method for cleaning a gas turbine engine component following a fluorescent penetrant inspection process. The method includes immersing the component in a cleaning solution and heating the component in a microwave oven while immersed in the cleaning solution for a period of time.

### BRIEF DESCRIPTION OF THE DRAWINGS

FIG. 1 is flow diagram illustrating a method for cleaning a gas turbine engine component with the use of a microwave oven.

FIG. 2 is a flow diagram illustrating a method for cleaning a gas turbine engine component with the use of a combination of a microwave oven and ultrasonic cleaning.

### DETAILED DESCRIPTION

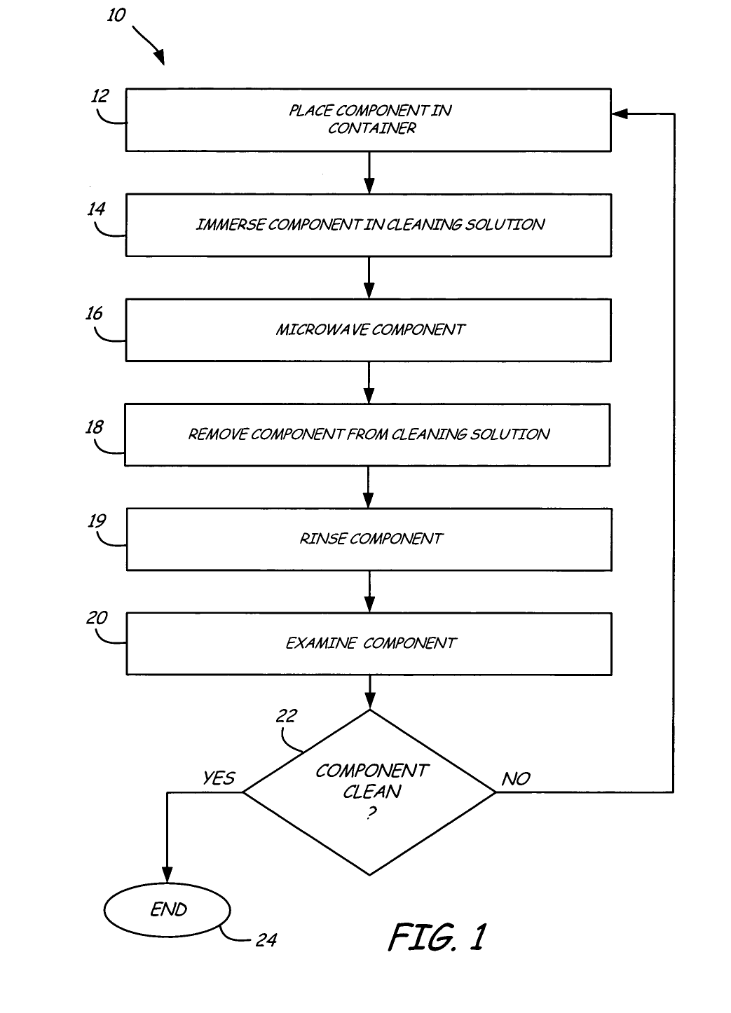

FIG. 1 is a flow diagram of method 10 for cleaning a gas turbine engine component with the use of a microwave oven. As discussed above, during operation, gas turbine engine components are exposed to extreme temperatures and pressures. Operating in such rigorous conditions results in stress being placed on components, especially turbine blades and vanes. Even though blades and vanes are specifically designed to withstand a great deal of stress, cracks may still form, which can potentially lead to catastrophic results. Therefore, an FPI process is used for inspecting gas turbine engine components to detect such abnormalities. During the FPI process the component to be examined is exposed to a penetrant and subsequently inspected under ultraviolet light. When this inspection process is completed, the excess penetrant must be removed from both the surface and any cavities (i.e. cracks, cooling holes, etc.) of the component.

Upon completion of the inspection process, the component must be cleaned to remove residual penetrant. It is important that all traces of penetrant are removed because residual penetrant often hinders subsequent processing of the component, such as welding or coating processes. Therefore, a quick and effective post-FPI cleaning method for gas turbine engine components is needed in the art.

Method 10 includes steps 12-22 and initially involves placing the component to be cleaned in a microwaveable container (step 12). Any microwaveable container of sufficient size may be used. In an exemplary embodiment, a large quartz bowl was used. However, any size microwaveable container or vessel may also be used depending on the size and quantity of the component(s) to be cleaned. A cleaning solution is then poured into the container until the component is immersed (step 14). Any suitable alkaline cleaning solution may be used. In addition, a simple soap solution may also be used. In an exemplary embodiment, an alkaline cleaning solution was used, such as sodium hydroxide or potassium hydroxide. In order to thoroughly clean the component, the component should be fully immersed in the cleaning solution. In an exemplary embodiment, about 2 liters of cleaning solution was added to the container. However, the invention is not so limited, and any suitable quantity of cleaning solution may be used.

The component is then heated in a microwave oven while it is immersed in the cleaning solution (step 16). The container, in which the component is immersed in the cleaning solution, is placed in the microwave oven. The microwave oven is turned on and is operated at a desired power level. In an exemplary embodiment, a 1 kilowatt microwave unit was operated at 50% power. However, the invention is not so limited, and any suitable microwave unit may be used at any suitable power level. For example, when method 10 is used to clean larger or multiple gas turbine components, a 6 kilowatt microwave unit may be used and operated at higher power setting for optimal cleaning.

The heating time may vary depending upon the setting and power level of the microwave oven and the amount of cleaning solution used. In an exemplary embodiment, 2 liters of solution was heated for 5 minutes in a 1 kilowatt microwave unit operating a 50% power. During the heating period, the solution reached a temperature of about 60 degrees Celsius. However, the invention is not so limited and the heating period may range from about 5 minutes to about 30 minutes.

After heating for the desired amount of time, the container is removed from the microwave oven, and the component is removed from the cleaning solution (step 18). The cleaning solution may be retained for additional heating steps.

The component is rinsed under running water or immersed in water to remove the cleaning solution from the component (step 19).

The component is then examined under an ultraviolet light source to evaluate the cleanliness of the component (step 20). The penetrant used during FPI typically fluoresces brightly when irradiated by long-wave ultraviolet radiation, in the approximate range of 300 to 400 nm. Therefore, dye penetrant which is still trapped in small voids such as cracks, seams or porous areas fluoresces when exposed to ultraviolet light. A decision must be made as to whether the component is satisfactorily clean (step 22). If no fluorescence is seen, the component is satisfactorily clean, and the component may be welded or coated successfully (24).

However, if fluorescence is visible on the component, method 10 may be repeated as many times as necessary, beginning with step 12, until the component is satisfactorily clean. When method 10 is repeated, the power level of the microwave oven and the heating time may be the same as the previous cleaning cycle or may vary.

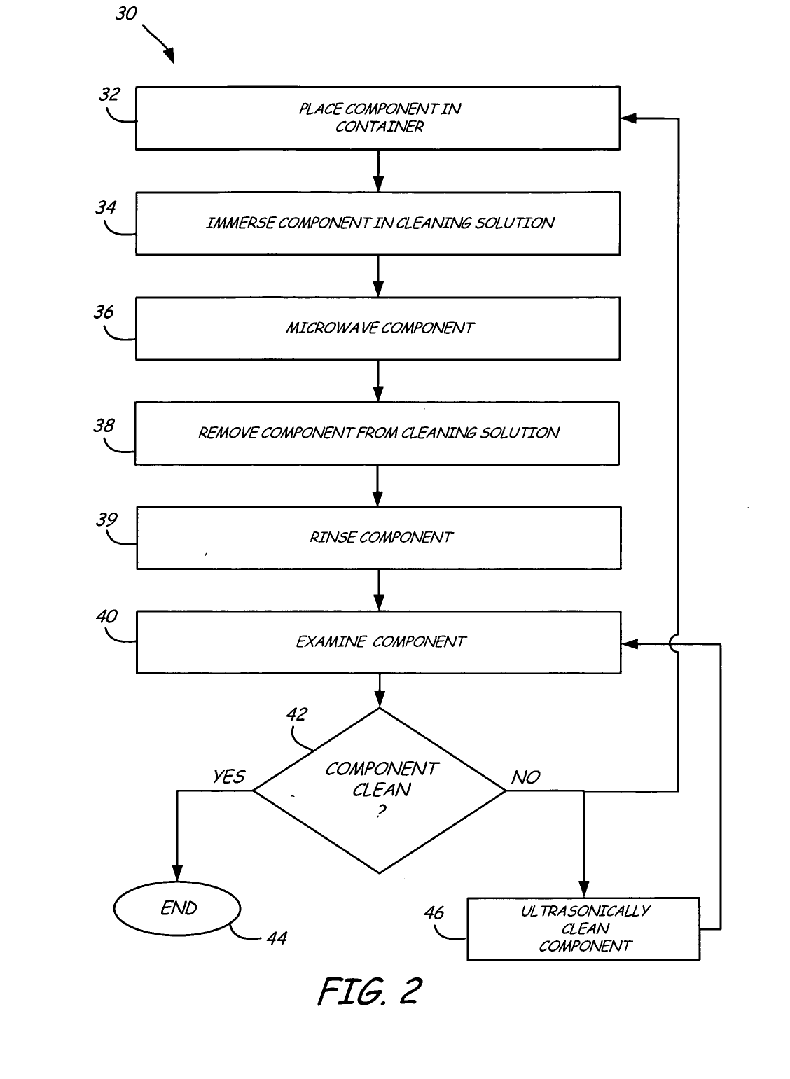

FIG. 2 is a flow diagram of method 30 for cleaning a gas turbine engine component with the use of a combination of a microwave oven and ultrasonic cleaning. Method 30 includes steps 32-46. As discussed above with reference to steps 12-22 in FIG. 1, steps 32-42 involve placing the component to be cleaned in a microwaveable container (step 32), pouring a cleaning solution into the container until the component is immersed (step 34), heating the component in a microwave oven while it is immersed in the cleaning solution (step 36), removing the component from the cleaning solution (step 38), rinsing the component with water (step 39), and examining the component under an ultraviolet light source to determine whether or not it is satisfactorily clean (steps 40 and 42).

If fluorescence is visible on the component, method 30 includes treating the component to an ultrasonic cleaning process (step 46). Ultrasonic cleaning typically involves placing the component in a chamber containing a suitable cleaning solution and activating an ultrasound beam from a transducer to produce ultrasonic waves in the solution. Microscopic cavitation bubbles are formed, which lift the residual penetrant out of the voids or cracks on the surface of the component.

After the ultrasonic cleaning process is completed and the component is removed from the solution, step 40 is repeated. The component is once again examined under an ultraviolet light source to evaluate the cleanliness of the component. If no fluorescence is seen, the component is satisfactorily clean, and the component may be welded or coated successfully (44). However, if fluorescence is still visible on the component, step 46 may be repeated as many times as necessary, until the component is satisfactorily clean. Alternatively, if fluorescence is still visible on the component, the entire process may be repeated again from steps 32 to 42 or 46, if desired, as many times as necessary, until the component is satisfactorily clean.

Although the present invention has been described with reference to preferred embodiments, workers skilled in the art will recognize that changes may be made in form and detail without departing from the spirit and scope of the invention.

1. A method for cleaning a gas turbine engine component following a fluorescent penetrant inspection process, the method comprising:
immersing the component in a cleaning solution;
heating the component in a microwave oven while immersed in the cleaning solution for a first period of time.

2. The method of claim 1, wherein the first period of time ranges from about 5 minutes to about 30 minutes.

3. The method of claim 1, and further comprising:
examining the component to determine whether a desired level of cleanliness has been achieved.

4. The method of claim 3, wherein the component is examined under an ultraviolet light source.

5. The method of claim 3, and further comprising:
reheating the component in the microwave oven while immersed in the cleaning solution for a second period of time when the desired level of cleanliness has not been achieved.

6. The method of claim 5, wherein the second period of time ranges from about 5 minutes to about 30 minutes.

7. The method of claim 3, and further comprising:
exposing the component to an ultrasonic cleaning process while immersed in the cleaning solution when the desired level of cleanliness has not been achieved.

8. The method of claim 1, wherein the component is completely immersed in the cleaning solution.

9. The method of claim 1, wherein the cleaning solution is an alkaline solution.

10. The method of claim 1, wherein the cleaning solution is heated to a temperature ranging from about 50 degrees Celsius to about 70 degrees Celsius.

11. The method of claim 1, wherein the microwave oven ranges from a 1 kilowatt unit to a 6 kilowatt unit.

12. The method of claim 1, wherein the microwave oven is operated at 50% of a full power level.

13. The method of claim 1, wherein the microwave oven is operated at a 100% of a full power level.

14. A method for cleaning a gas turbine engine component following a fluorescent penetrant inspection process, the method comprising:
immersing the component in a cleaning solution;
heating the component in a microwave oven while immersed in the cleaning solution for a first period of time;
examining the component under an ultraviolet light source to detect a residual amount of a penetrant; and
determining whether a desired level of cleanliness has been achieved.

15. The method of claim 14, wherein the first period of time ranges from about 5 minutes to about 30 minutes.

16. The method of claim 14, and further comprising:
reheating the component in the microwave oven while immersed in the cleaning solution for a second period of time when the desired level of cleanliness has not been achieved, wherein the reheating step occurs as many times as necessary until the desired level of cleanliness has been achieved.

17. The method of claim 16, wherein the second period of time ranges from about 5 minutes to about 30 minutes.

18. The method of claim 14, and further comprising:
exposing the component to an ultrasonic cleaning process while immersed in the cleaning solution when the desired level of cleanliness has not been achieved, wherein the exposing step occurs as many times as necessary until the desired level of cleanliness has been achieved.

19. A system for cleaning a gas turbine engine component following a fluorescent penetrant inspection process, the system comprising:
a cleaning solution;
a microwaveable container for receiving the component and the cleaning solution such that the component is immersed in the cleaning solution;
a microwave oven for heating the component while it is immersed in the cleaning solution; and
an ultraviolet light source for examining the component.

20. The system of claim 19 and further comprising:
an ultrasonic cleaning apparatus for receiving the component and the cleaning solution such that the component is immersed in the cleaning solution wherein the ultrasonic cleaning apparatus causes the cleaning solution to bubble.
